(19) United States
(12) Patent Application Publication
(10) Pub. No.: US 2004/0047798 A1
(43) Pub. Date: Mar. 11, 2004

(54) Mesoporous carbon material, carbon/metal oxide composite materials, and electrochemical capacitors using them

(76) Inventors: Seung Mo Oh, Ahanyang-City (KR); Taeg Hwan Hyeon, Seoul (KR); Jong Hyun Jang, Seoul (KR); Song Hun Yoon, Seoul (KR)

Correspondence Address: Mavis S Gallenson, Ladas & Parry, Suite 2100, 5670 Wilshire Boulevard, Los Angeles, CA, 90036-5679, US

(21) Appl. No.: 10/276,194

(22) PCT Filed: Dec. 29, 2000
(86) PCT No.: PCT/KR00/01555

(30) Foreign Application Priority Data
May 24, 2000 (KR) 2000/0028219
Oct. 20, 2000 (KR) 2000/0061845

(51) Int. Cl. C01B 31/00

(52) U.S. Cl. 423/414; 423/445 R

(57) ABSTRACT

The present invention is related to carbon materials having 2-20 nm of mesopore and high porosity, carbon/metal oxide composites which are prepared with said material and wherein metal oxides are deposited in the pores, electrical double-layer capacitors prepared with said carbon material, and electrochemical capacitors prepared with said carbon/metal oxide composite. When the mesoporous carbon is used as an electrode material of electrical double-layer capacitors, in spite of low capacitance value per weight for low surface area, said electrical double-layer capacitor has higher charge storage volume than the previous ones due to low equivalent series resistance. Furthermore, when said carbon/metal oxide composite is used as an electrode material of electrical double-layer capacitor, the capacitor has high capacitance value per unit weight, i.e., 254 F/g, by combining the electrical double-layer capacitor with the pseudo capacitor from the metal oxide.

### TECHNICAL FIELD

The present invention is directed to carbon materials with mesopores (pore size: 2 to 20 nm) and high porosity, carbon/metal oxide composite materials synthesized by deposing metal oxides to the mesoporous carbons, electric double layer capacitors using the mesoporous carbons, and electrochemical capacitors using the carbon/metal oxide composite materials.

### BACKGROUND ART

Recently, the development of supercapacitors became very important for the load leveling of the electric power sources, including batteries (including rechargeable cells) and fuel cells, for new mobile communication (IMT-2000) and electric vehicles that require high pulse power. By connecting the electrochemical capacitors having excellent power output to the batteries or fuel cells having high energy density in parallel, it is possible to satisfy the need for pulse power output and extend the lifetime of batteries and fuel cells.

In general, the electrochemical capacitors are classified into electric double-layer capacitors (EDLC) and pseudo capacitors. The EDLC stores electricity by charging ions on electrolytes and electrons on electrodes, respectively, at the electric double layer formed at the electrode/electrolyte interface. The pseudo capacitors store electricity near the electrode surface by using the faradaic reaction.

The double layer capacitor is composed of the equivalent circuit wherein double-layer capacitance and equivalent series resistance (ESR) are connected in series. The double-layer capacitance is proportional to the surface area of electrode, and the ESR is the sum of electrode resistance, electrolyte solution resistance, and electrolyte resistance in the electrode pores. The electric charges stored in the double-layer capacitance decrease as the charge/discharge rate increases; the ESR determines the degree of storage decrease. Namely, the storage amount of charges decreases as the ESR increases and such phenomenon becomes large as the charge/discharge rate increases.

Generally, carbon materials are used as the electrode materials for double-layer capacitors, and the followings are the requirements of the carbon materials for good double-layer capacitor performance:

1) High specific surface area with high porosity

2) High electric conductivity for small electrode resistance

3) Sufficiently wide and connected pores, enabling pore surface easily wetted by electrolyte solution to form large electric double-layer and fast charge/discharge by fast ion mass transfer in pores

So far, the powder and fiber form of activated carbons have been used for electrode material of EDLC, but these activated carbons have the following shortcomings in the aspect of above-mentioned requirements for EDLC.

Firstly, although they have high capacitance due to large specific surface area, micropores (less then 2 nm in diameter), mesopores (from 2 to 10 nm) and macropores (more than 10 nm) are contained together in them, and most of pores are the micropores. Therefore, the microporous and disordered pore structures limit their application to the electrode materials of EDLC because (i) the micropores cannot be fully wetted, and (ii) there is large resistance in pores because of hindered ion transfer in narrow pores.

Secondly, these activated carbon powers have low bulk electric conductivity due to irregularly connected pores and irregularly aggregated carbon primary particles. The bulk electric conductivity can be improved by adding conducting materials such as carbon blacks, however, the energy density of EDLC decreases in both per weight and per volume.

Consequently, for the purpose of using EDLC as electric source of the high-power-demand devices, the ESR should be minimized in addition to the high capacitance. To decrease the ESR, the electrode materials should have (i) high electric resistance, (ii) mesopores (2-20 nm in diameter) rather than micropores, and (iii) 3-dimensionally connected pore structure (more desirable), which allows effective ion transfer between pores.

Regarding carbon materials for the EDLC application, Y. Z. Zhang et al. modified the pore structure of activated carbon powder and fiber by heat-treatment with calcium hydroxide and CO-activation. (Carbon 24^{th} Biennial Conference on Carbon 11-16, p.434 (1999)). Through this method it is possible to control pore size of the carbon, however the regularity and connectivity of pores cannot be achievable.

Ryong Ryoo et al. reported the preparative method for porous carbon molecular sieve by (i) filling the cubic mesoporous silica molecular sieve such as MCM48, which serves as a template, with sucrose and acidic catalyst, (ii) carbonization of sucrose by heating at 800-1100° C. under vacuum or inert gas, and (iii) removing the silica template with sodium hydroxide (Physical Chemistry, 1999). However, this method requires very expensive cubic mesoporous silica molecular sieve as template, and the pore structures are determined by template structure that cannot be easily controlled. Their carbon powder possesses narrow pores with average diameter of 2 nm, in spite of their desirable connected pore structure.

Meanwhile, the EDLC has lower specific capacitance than pseudo-capacitor, and thus the combination of EDLC and pseudo-capacitor is required.

In other words, since the EDLC using solely carbon has relatively low capacitance, the specific capacitance of an EDLC can be increased by deposing pseudo-capacitor material. Large pores are required in order to use pore surface thoroughly, which enables the high deposition. In this respect, the activated carbon/fiber and mesoporbus carbon by Ryong Ryoo is not suitable for the deposition of pseudo-capacitor material.

Metal oxides, such as RuOₓ, IrOₓ, TaOₓ, MnOₓ, have pseudo-capacitor property. By using RuOₓ, high specific capacitance over 700 F/g is possible. However, its high price limits commercialization by itself. In addition, some metal oxides have low electric conductivity, making it difficult to be used in thick film form and under high current condition.

### DISCLOSURE OF INVENTION

Therefore, the present invention has a purpose to solve above-mentioned technical problems.

The first purpose of the present invention is to provide mesoporous carbons by using inorganic particles as templates, which can be used for the electrode material of EDLC. In detail, inorganic particle templates are mixed with carbon precursor to form template/carbon precursor composite, which is carbonized by heat-treatment to get carbon/template composite. Mesoporous carbons are prepared when the templates are removed. The space occupied initially by the templates becomes pores. One of the important concepts is that pore size and shape can be controlled by using a appropriate inorganic template particles, because these pore structures are determined by the structures of the inorganic templates.

The second purpose of the present invention is to provide mesoporous carbon/metal oxide composite materials which have both EDLC (carbon) and pseudo-capacitor (metal oxide) characteristics. The above-mentioned mesoporous carbons, which have mostly mesopores (2-20 nm), are suitable for the deposition of metal oxide precursor. In addition, their high surface areas enable high EDLC capacitance.

The third purpose of the present invention is to provide EDLCs having high EDLC performance under high charge/discharge rate condition by using as electrodes the mesoporous carbons which have high electric conductivity, wide mesoporous (2-20 nm), and highly connected pore structure so as to minimize the ESR.

The fourth purpose of the present invention is to provide electrochemical capacitors with high specific capacitance by using the mesoporous carbon/metal oxide composite materials as electrodes, which have EDLC (carbon) and pseudo-capacitance (metal oxide) properties simultaneously.

To achieve these purposes, the contents of the present invention are described below.

Firstly, in the present invention, the “mesoporous carbon” is synthesized by following procedures as:

(A) Preparing “inorganic template/carbon precursor composite”, in which the inorganic template particles are dispersed in the carbon precursor solution,

(B) Preparing “inorganic template/carbon composite” by the carbonization of carbon precursors surrounding the inorganic template through heat-treatment for from 0.5 to 50 hours at from 600 to 1500° C., and

(C) Removing the inorganic template from the inorganic template/carbon composite by base or acid etching, and drying.

The synthesized carbons possess pores of sizes ranging between 2 to 20 nm.

In said step (B), the carbon precursors surrounding inorganic template are carbonized. The shape and size of inorganic template particles can be selected in order to control the pore structure of synthesized carbon. The shape of inorganic template particles is not limited and includes spheres, ellipsoids, cubes, and linear shapes. For example, the spherical inorganic particles generate pores with closed structure, whereas the linear templates generate open pore systems. The templates of linear and modified extended form are more preferable because carbons with interconnected open pores can be produced, which are suitable for the EDLC application. The particle size of the inorganic templates is above 1 nm and preferably 2 to 20 nm, which corresponds to the size of the pores produced finally.

For inorganic templates, silica, alumina, titania TiO₂), ceria (CeO₂), etc. can be used. Among them the silica is particularly preferable because it can be easily removed by weak acid or alkali solution in addition to its low price.

Many kinds of silica materials are commercially available including spherical silica such as LUDOX HS-40, LUDOX SM-30 and LUDOX TM-40 (DuPont) and linear silica such as SNOWTEX-UP (Nissan chemical). The silica templates other than commercial products may be easily prepared, for example, by sol-gel reaction (hydrolysis and condensation) of sodium silicate, tetraethoxy orthosilicate or the like with acid or base catalyst. Additionally, varying the reaction parameters can control the shape and size of generated pores. As a result, carbon materials with pores of various shapes and sizes desired can be synthesized.

As mentioned in the prior art techniques section, the mesoporous silica molecular sieves, such as MCM-48, are not included in the templates of the present invention. The reason is that, in addition to the high price, the skeleton of silica molecular sieves is fixed so that the pore structure of carbon cannot be controlled. Namely, carbon precursors enter the pores of silica molecular sieves and then are carbonized therein, whereby the pore structure of carbon is determined depending on the structure shape of silica molecular sieves. On the contrary, the inorganic template in the present invention does not have a fixed structure, which enables carbon pore to be designed by controlling of the inorganic template/carbon precursor composite formation condition. Another characteristic of the present invention is that the structure of inorganic template, which is removed by acid or base etching in said step (C) to leave pores in carbon, is determined by the synthesis parameters for inorganic template/carbon precursor composition in said step (A). In short, the shape of inorganic template and other reaction conditions can control the pore structure of carbon.

If desired, surfactants can be added to the precursor solution in order to achieve homogeneous dispersion of template particles and to control the shape of inorganic template during the synthetic process. Some of inorganic template particles, which exist as sol in solution, agglomerate during the mixing with carbon precursor, as a result, the generated pores tend to have larger pore size than expected from the particle size of the silica sol template. Therefore, the final pore size of carbon can be controlled by adjusting the agglomeration using surfactant. The possible surfactants are as follows: the cation surfactant including alkyl trimethylammonium halides, the neutral surfactants including oleic acids and alkyl amines, and the anion surfactants including sodium alkyl sulfates and sodium alkyl phosphates. For example, silica particle, whose surface is negatively charged, needs cationic surfactants such as cetyltrimethylammonium bromide (CrAB), cetyltrimethylammonium chloride (CTAC), tetradecyltrimethylammonium bromide, tetradecyltrimethylammonium chloride, dodecyltrimethylammonium bromide, dodecyltrimethylammonium chloride and the like.

Any other surfactant, which is not listed above, can be used if it is suitable for the present invention.

Any kinds of carbon materials can become the carbon precursor of the present invention if they can disperse the inorganic template particles and be carbonized by heat-treatment. Some examples are resorcinol-formaldehyde-gel (RF-gel), phenol-formaldehyde-gel, phenol resin, melamine-formaldehyde-gel, poly(furfuryl alcohol), poly(acrylonitrile), sucrose, petroleum pitch, etc.

In case that carbon precursor is the RF-gel, aqueous sol containing inorganic template particles in 20 to 60% by weight and aqueous solution with resorcinol/formaldehyde mixture (mole ratio, 1:2-1:3) in 30 to 70% by weight are prepared, respectively. The inorganic template/carbon precursor composites are prepared by mixing these solutions at the weight ratio of 1:1 to 1:20 (resorcinol-formaldehyde: inorganic template) followed by polymerizing at 20 to 95° C. In case that the inorganic template is the silica, polymerization of resorcinol and formaldehyde needs no additional catalyst because silica sol solution is weak alkaline and that can act as catalyst by itself for the polymerization reaction of resorcinol and formaldehyde. To accelerate the polymerization reaction, catalysts such as sodium carbonate may be added to the solution.

In case that carbon precursor is phenol resin, melamin-formaldehyde-gel, poly-furfuryalcohol, poly-acrylonirile, or petroleum pitch, aqueous inorganic template sol (containing 20 to 60% by weight of inorganic template particles) and carbon precursor organic solution (containing 10 to 99% by weight of inorganic template particles) are mixed homogeneously at the weight ratio of 1:1 to 1:20 (phenol resin, etc.: inorganic template), whereby inorganic template/carbon precursor composite is prepared in said step (A).

When the carbon precursors are prepared from the polymeric monomers, the inorganic template/carbon precursor composite can be synthesized through the well-known methods according to the characteristics of monomers.

The solution after said step (A) may be aged for from 1 to 10 days to strengthen polymer structures, where the aging means maintaining the solution at fixed temperature in the range of room temperature to 120° C. for certain period. After the aging, the washing by distilled water is desirable.

In said step (C), where the inorganic template particles are etched by acid or base to form mesoporous carbon, fluoric acid (HF) or sodium hydroxide (NaOH) solution can be used as etching agent for the silica inorganic template particle. For example, in the case of HF, the silica template particle/carbon composite solution is stirred in the HF solution of 20 to 50% for 05 to 50 hours to eliminate silica templates.

In addition, the present invention is directed to “mesoporous carbon/metal oxide composite material”, which is prepared by loading metal oxides (pseudo-capacitor material) in the pores of “mesoporous carbon” which has mesoporous of 2 to 20 nm and high porosity.

When the mesoporous carbon/metal oxide composite material according to the present invention is used for the electrode material of electrochemical capacitors, improved specific capacitance is obtained through the combination of the double-layer capacitance of carbon and the pseudo-capacitance of metal oxides loaded in carbon pores.

Accordingly, the metal oxides with pseudo-capacitor characteristic should be deposited in carbon pores easily and as much as possible. In this respect, the carbon pore size should be optimized in the range of 2 to 20 nm. When the pore is smaller than 2 nm, the deposition becomes difficult, and the electrochemical capacitor shows lower performance due to narrow pores. On the other hand, when the pore is larger than 20 nm, the double-layer capacitance of carbon becomes low because of small specific surface area, though the deposition of metal oxides is improved for their large pores. The more preferably pore size is from 5 to 15 nm.

The oxides of transition metals, such as Ti, Zr, V, Nb, Ta, Cr, Mo, W, Mn, Fe, Co, Ir, Ni, Pd, Ru, etc., can be loaded into the pores of mesoporous carbon.

The mesoporous carbon/metal oxide composite material can be synthesized by deposing metal oxide precursor in the pores of carbon and conversing the precursor to metal oxides: more specifically,

(a) Forming composite of mesoporous carbon and metal oxide precursor, and

(b) Conversing the composition of mesoporous carbon/metal oxide precursor to mesoporous carbon/metal oxide by heat-treatment.

In said step (a), the mesoporous carbon/metal oxide precursor can be prepared by gas phase method or liquid phase method.

The gas phase method for the mesoporous carbon/metal oxide precursor composite includes such steps as:

(a-1) Mixing of mesoporous carbon and metal oxide precursor in a reactor,

(b-1) Sublimation of the solid metal oxide precursor to form gas phase under reduced pressure, and

(c-1) Loading of the metal oxide precursor into the pores of mesoporous carbon by cooling of the reactor.

In said step (a-1), the metal oxide precursors can be one or a mixture of two or more selected from the group consisting of acetylacetonates, chlorides, fluorides, sulfuric salt, and nitric salt of transition metal elements (Ti, Zr, V, Nb, Ta, Cr, Mo, W, Mn, Fe, Co, Ir, Ni, Pd, Ru). For example, ruthenium (III) acetylacetonate ([CH₃COCH═C(O—)CH₃]₃Ru), cobalt (II) acetylacetonate, cobalt (III) acetylacetonate, nickel (II) acetylacetonate ([CH₃COCH═C(O—)CH₃]₂Ni), manganese (II) acetylacetonate ([CH₃COCH═C(O—)CH₃]₂Mn), manganese (III) acetylacetonate, and others can be used for metal oxide precursor. The mesoporous carbon and metal oxide precursors are mixed in the weight ration of 1:0.1 to 10.

In said step (b-1), the metal oxide precursor is heated under vacuum up to the sublimation temperature so that it can exist as vapor state in the pores of the carbon.

In said step (c-1), the interior surface of pore, which has high negative curvature, is favored for the deposition of metal oxide precursor. As the result, the deposition occurs in pores preferentially during cooling, so that there is a mass transfer of vapor phase precursor into pores, which is caused by the difference of partial pressure of precursor vapor. The cooling condition can be adjusted by such methods as cooling rate variation (0.1 to 10° C./min), different cooling rates at different temperature range, and holding step at a fixed temperature.

The liquid phase method for preparing mesoporous carbon/metal oxide precursor composite includes such steps as:

(a-2) Placing mesoporous carbon in a reactor and reducing pressure,

(b-2) Injection of metal salt solution into the reactor to be infiltrated into carbon pores, and

(c-2) Eliminating solvent to form mesoporous carbon/metal oxide precursor composite materials.

In said step (a-2), by heating under vacuum, water, organics and the like are removed from the carbon pores.

In said step (b-2), the metal oxide precursor for the preparation of the metal salt solution can be one or a mixture of two or more selected from the group consisting of nitric salts, sulfuric salts, carbonates, acetylacetonates, bromides, chlorides, fluorides, and hydroxides of transition metal elements (e.g. Ti, Zr, V, Nb, Ta, Cr, Mo, W, Mn, Fe, Co, Ir, Ni, Pd, Ru). The solvent for the metal salt solution can be one or a mixture of two or more selected from the group of consisting of water, acetone, methanol, ethanol, and others. The amount of injected metal salt solution is, for example, 5 to 50 ml of 0.01 to 2M solutions per 100 mg of the mesoporous carbon. The final contents of metal oxides can be controlled by the concentration and injection volume of metal salt solution. Stirring can be helpful to improve wetting and homogeneity.

In said step (c-2), the elimination of solvent can be performed under atmospheric pressure at the temperature of from 20° C. to boiling point of the solvent. For example, water solvent can be eliminated by slow evaporation at 90 to 98° C., enabling the local deposition in pores and the diffusion by concentration difference.

The mesoporous carbon/metal oxide precursor composite materials prepared in said step (a) is converted to mesoporous carbon/metal oxides composite by heat-treatment in said step (b), which is carried out under inert gas (argon, nitrogen, helium, etc.) at the flow rate of 1 to 20 cc/min with heating rate of 1 to 10° C./min up to the temperature of 100 to 500° C. Then, the reactor is held at that temperature for 5 min to 30 hours.

The present invention is also directed to the EDLC using the mesoporous carbon as electrode material.

The EDLC is composed of electrodes, made by application of the mesoporous carbons on current collectors, separators inserted between the electrodes, and electrolytes in the separators. Details are as follows.

The electrode is fabricated in order to use the synthesized mesoporous carbon as electrode material for the EDLC. For example, the mesoporous carbon powder and a binder are added to the dispersing agent with the weight ratio of 10:0.5 to 2 and mixed to form pastes, which is applied to the metal current collector, pressed, and dried to form laminated-type electrodes.

The representative examples of binders are polytetrafluoroethylene (PTFE), polyvinylidene fluoride (PVdF), cellulose, etc. and the representative examples of dispersing agents include isopropyl alcohol, N-methylpyrrolridone (NMP), acetone, etc.

For the current collector, any metal is possible as long as it has high electronic conductivity and paste can be applied easily on it. Usually, mesh and foil made of stainless steel, titanium, and aluminum are used. The application method for electrode material paste on the metal can be selected among the well-known methods and newly developed method. For example, the paste is distributed on current collector and homogeneously dispersed by equipments such as doctor blade. Other methods as die casting, comma casting, and screen-printing can be used. In addition, the electrode is formed on substrate, and connected to current collector by pressing or lamination method.

The applied paste is dried in vacuum oven at 50 to 200° C. for 1 to 3 days.

In some cases, 5 to 20% by weight of carbon black can be added as a conducting material to decrease the electric resistance of electrode. Commercial conducting materials include acetylene black series (Chevron Chemical Company and Denki Kagaku Kogyo KK), Ketjenblack EC series (Armak Company), Vulcan XC-72 (Cabot Company), and Super P (MMM).

The electric double-layer capacitor with mesoporous carbon electrodes are manufactured by using carbon electrodes both as a working electrode and a counter electrode, inserting one separator between two electrodes, and infiltrating an electrolyte solution into the separator.

The electrolyte solution is infiltrated into the separator and the electrodes by repeating 5 to 20 times cycles of either dipping the electrodes in the electrolyte solution for 1 to 3 days or dropping the electrolyte solution on the electrodes (1 to 10 ml per 1 cm²) followed by aging under vacuum over 2 hours. The mesoporous carbon in the present invention has advantages of taking shorter time to be infiltrated by the electrolyte solution than conventional activated carbon materials.

The separator prevents the internal short circuit between two electrodes and it contains the electrolyte solution. For separators, polymer, glass fiber mat, and craft paper can be used. The commercially available separators are Celgard type products (Celgard 2400, 2300: Hoechst Celanese Corp.), polypropylene membrane (Ube Industries Ltd., Pall RAI's products), etc.

Aqueous electrolyte solutions for EDLC are 5-100 weight percent sulfuric acid solution, 0.5 to 20M potassium hydroxide solution, and neutral electrolytes such as 0.2 to 10M of potassium chloride, sodium chloride, potassium nitrate, sodium nitrate, potassium sulfate, and sodium sulfate solution.

The EDLCs according to the present invention have specific capacitance of 50 to 180 F/g and low electrolyte resistance in pores (e.g., ESR of 0.05 to 2 Ωm² with 20 to 1000 μm thick electrode) resulting from fast ion transfer in regularly connected mesopores, enabling high performance in high charge/discharge current densities (Acm⁻²).

The present invention is also directed to the electrochemical capacitors made of the mesoporous carbon/metal oxide composite material. Namely, the electrochemical capacitor according to the present invention is composed of electrodes prepared by applying the mesoporous carbon/metal oxide composite material on current collector, separators inserted between electrodes, and electrolyte solutions retained in the separators. The technical details are same as that of EDLC.

The following examples include the detailed description of mesoporous carbon and mesoporous carbon/metal oxide composite material synthesis; and the experiments for the performance of EDLC and electrochemical capacitor prepared by using them. However, these examples are not intended to restrict the scope of the invention.

The Synthesis of Mesoporous Carbon by Using Structure Directing Agent

### EXAMPLE 1

A resorcinol and formaldehyde mixture (1:2 mole ratio) was added to LUDOX SM-30 silica aqueous sol to be the final mole ratio of 1:2:7.5:86 (resorcinol:formaldehyde:silica:water). The pH of the mixture solution was adjusted to 8 by adding 1N sodium hydroxide aqueous solution and 1N nitric acid solution. The mixture solution was condensed and aged at 85° C. for 3 days to form resorcinol-formaldehyde-gel/silica composite. This composite was heated at 850° C. in nitrogen and converted to a carbon/silica composite, which is etched in 48% hydrofluoric acid for 12 hours with stirring to remove the silica, leaving a mesoporous carbon. The mesoporous carbon synthesized had the specific surface area of 847 m²/g and the pore volume of 2.6 cc/g. The 99% of pores was larger than 2 nm, and the electric conductivity, measured by Aida's method (Carbon, 24, 337 (1986)), was 7.2S/cm. In FIG. 1, the schematic procedure of example 1 is presented. FIG. 4 shows the pore size distribution of synthesized mesoporous carbon, measured by nitrogen adsorption method.

### EXAMPLE 2

A mesoporous carbon was synthesized by the same method as example 1 with an exception that LUDOX HS40 silica was used instead of LUDOX SM-30. The mesoporous carbon synthesized had the specific surface area of 950 m²/g, the pore volume of 5.5 cc/g, and the average pore size of 23 nm. In addition, this carbon had large pores (>2 nm) in 96%. FIG. 2 shows the SEM (scanning electron microscopy) image of synthesized carbon with the magnification of 75,000. As presented in FIG. 2, the pore size is ranging between 10 nm and 100 nm.

### EXAMPLE 3

A silica was formed by adding 5 g cetyltrimethylammonium bromide to 100 ml of LUDOX SM-30 silica aqueous sol, which was stabilized by surfactants. The remaining surfactants were removed by washing with 100 ml of distilled water in 3 to 5 times. To this surfactant-stabilized silica sol solution, a mixture of resorcinol, formaldehyde, sodium carbonate, and water (1:2:0.015:5.6 in mole ratio) was added dropwise to fully wet silica, wherein the sodium carbonate was used as a catalyst for resorcinol and formaldehyde to form gel. The mixture solution was aged at 85° C. for 3 days to form resorcinol-formaldehyde-gel/silica composite, which was heated at 850° C. in nitrogen for 3 hours to be transformed to a carbon/silica composite. The final mesoporous carbon was obtained by removing the silica in the resultant composite by etching in 48% fluoric acid with stirring for 12 hours. This carbon had the specific surface area of 1090 m²/g, the pore volume of 1.7 cc/g, and the average pore size of 8 nm. The mesopores, larger than 2 nm, were 99%. The electric conductivity, measured by Aida's method (Carbon, 24, 337 (1986)) at 1000 psi, was 10 S/cm. The schematic procedure was presented in FIG. 3.

### EXAMPLE 4

A mesoporous carbon was synthesized by the same method as example 3 with an exception that LUDOX HS40 silica was used instead of LUDOX SM-30. The mesoporous carbon thus prepared had the specific surface area of 1510 m²/g and the pore volume of 3.6 cc/g. The mesopores, larger than 2 nm, were over 99%. As can be seen from FIG. 5, the uniform pores of 12 nm were observed in the transmission electronic microscope (TEM: ×250,000).

### EXAMPLE 5

With the exception that SNOWTEX-UP silica sol (linear silica with diameter of 8 nm) was used instead of LUDOX SM-30 silica, the same procedure as in Example 3 was adopted to prepare a mesoporous carbon. The mesoporous carbon thus synthesized had the specific surface area of 1087 m²/g and the pore volume of 2.1 cc/g. The portion of pores larger than 1.7 nm was over 86% and most of the pores have the pore size of over 8 nm. In FIG. 6, the schematic procedure of the present example is presented. The final mesoporous carbon had the uniform pores of 8 nm, as shown in FIG. 7. In TEM photograph, the well-developed connectivity of pores could be observed in FIG. 8. The electrical conductivity, measured by Aida's method (Carbon, 24, 337 (1986)) at 1000 psi, was 8.5S/cm.

The Synthesis of Mesoporous Carbon/Metal Oxide Composite Materials

EXAMPLE 6

50 mg of mesoporous carbon prepared in Example 1 and 40 mg of ruthenium acetylacetonate were placed in a round-bottomed flask, and evacuated. Under static vacuum, the mixture were heated to 190° C., maintained for 2 hours, and cooled to room temperature at 3° C./min. The resultant powder was heat-treated at 320° C. for 2 hours in argon.

### EXAMPLE 7

A mesoporous carbon/metal oxide composite material was synthesized with same procedure as Example 6, using mesoporous carbon prepared in Example 5 and cooling at the slower rate of 0.1° C./min. FIG. 9. shows the thermogravimetry analysis (TGA), indicating 14% of residue, which corresponds metal oxide, after heating up to 900° C. in air.

### EXAMPLE 8

A mesoporous carbon/metal oxide composite material was synthesized using the carbon prepared in Example 3 and two step cooling scheme, 0.1° C./min to 170° C. and 2° C./min to room temperature. Other procedures were the same as Example 6.

### EXAMPLE 9

A mesoporous carbon/metal oxide composite material was synthesized as Example 6, except for that the cooling to room temperature was performed at 1° C./min instead of 3° C./min and the addition of ruthenium acetylacetonate 40 mg was repeated two times. FIG. 9 and FIG. 10 show the TGA analysis result and the pore size distribution measured by nitrogen adsorption, respectively. In FIG. 10, it is confirmed that the mesoporous carbon/metal oxide composite material maintains the mesoporous characteristic as a mesoporous carbon.

### EXAMPLE 10

100 mg of the mesoporous carbon prepared in Example 1 was placed in a round-bottomed flask, was heated to 80° C. under reduced pressure to remove residual water and organic materials, and was cooled down to room temperature. With maintaining static vacuum, 37 ml of 0.02M ruthenium chloride solution was added to the mesoporous carbon and stirred for 1 hour to fully wet the pores. After removing the static vacuum and holding at 95° C., water was slowly evaporated to induce local deposition and diffusion by the concentration difference. After slow drying, the powder was heat-treated at 320° C. in argon to form the mesoporous carbon/metal oxide composite material.

### EXAMPLE 11

A mesoporous carbon/metal oxide composite material was synthesized with the same procedure as Example 10, with the exception of using 50 ml of ruthenium chloride solution instead of 37 ml.

### EXAMPLE 12

A mesoporous carbon/metal oxide composite material was synthesized with the same procedure as Example 6, with the exception of using 44 mg of nickel acetylacetonate instead of 40 g of ruthenium acetylacetonate. FIG. 11 shows the TEM photograph of the synthesized composite powder.

### EXAMPLE 13

A mesoporous carbon/metal oxide composite material was synthesized with the same procedure as Example 6, with the exception of using 40 mg of manganese acetylacetonate instead of 40 mg of ruthenium acetylacetonate.

Manufacturing and Performance Measurement of EDLC

### EXAMPLE 14

The capacitor performance was measured for carbons in Example 1 (“carbon-1”), Example 3 (“carbon-2”), and Example 5 (“carbon-3”) in 1M electrolyte solution prepared by dissolving tetraethylammonium tetrafluoroborate (Et₄NBF₄) in propylene carbonate.

For electrode fabrication, a 10:1 ratio mixture of one of carbons-1 to -3 and the polytetrafluoroethylene binder was dispersed in an isopropyl alcohol. The prepared paste was applied by doctor blade to the current collector (1 cm² of stainless steel grid), pressed, and then dried in a vacuum oven at 120° C. for 24 hours to make carbon electrodes. A polymer separator (Celgard) was inserted between two identical electrodes, and pressed by a clip. After electrolyte solution was injected to the electrodes, the charge/discharge test was performed at the constant current of 0.01 to 0.1A/cm² in the voltage range of 0 to 3V. The specific charge storage was calculated by dividing consumed charge by carbon mass. The variation of specific charge storage (mAhg⁻¹) according to the current density (Acm⁻²) and the specific capacitance (F/g) are presented in FIG. 12 and TABLE 1, respectively.

For Comparison, the Same EDLC Test was Performed for the Capacitor Prepared using MSC25 (Molecular Sieving Carbon, Average Pore Diameter<2 nm, Manufactured by Kansai Coke and Chemicals) as Carbon Materials.

### EXAMPLE 15

The capacitor test was performed with the same method as Example 14, with the exception that 30% sulfuric acid aqueous solution was used as an electrolyte solution and the applied voltage range was from 0.0 to 0.8V. The specific charge storage was plotted according to the charge/discharge current density (A/cm²) in FIG. 13, and the specific capacitance (F/g) is listed in TABLE 1.

For comparison, the same EDLC test was performed for the capacitor prepared using MSC25 (molecular sieving carbon, average pore diameter<2 nm, manufactured by Kansai Coke and Chemicals) as carbon materials.

### EXAMPLE 16

The capacitor test was performed with the same method as Example 14, with the exception that 3M potassium hydroxide aqueous solution was used as an electrolyte solution and the voltage range was from 0.0 to 0.8V. The specific charge storage is plotted according to the charge/discharge current density (A/cm²) in FIG. 14, and the specific capacitance (F/g) is listed in TABLE 1.

For comparison, the same EDLC test was performed for the capacitor prepared using MSC25 (molecular sieving carbon, average pore diameter<2 nm, manufactured by Kansai Coke and Chemicals) as carbon materials.

TABLE 1

| | | | Specific Capacitance (F/g) | | |
|---|---|---|---|---|---|
| | | | Example 14 | Example 15 | Example 16 |
| | Specific | Electric | 1M Et_{4pl NBFphd 4}/ | (30% sulfuric | (3M Potassium |
| | Surface | Conductivity* | Propylene | acid aqueous | hydroxide |
| | Area (m²g⁻) | (Scm⁻¹) | Carbonate) | solution) | aqueous solution) |
| MSC25 | 1970 | 1.1 | 133 | 230 | 97 |
| Carbon-1 | 847 | 7.2 | 70 | 120 | 50 |
| (Example 1) | | | | | |
| Carbon-2 | 1090 | 10 | 85 | 145 | 60 |
| (Example 3) | | | | | |
| Carbon-3 | 1087 | 8.5 | 102 | 175 | 73 |
| (Example 5) | | | | | |

*Electric conductivity was measured by Aida's method at 1000 psi.

As suggested in TABLE 1, comparing conventional used MSC25, it is possible for Carbon-1, 2, 3 in the present invention to be fabricated into the electrodes of EDLC without additional conducting agent because of their high electric conductivity (>7S/cm as powder), while their large pores lower the specific surface area.

Even though the capacitors containing the carbons according to the present invention have smaller capacitance than those containing MSC25, there is only small decrease of charge storage capacity for the carbons according to the present invention with increased current density, as shown in FIG. 12 and FIG. 14, in contrast to the MSC25 electrodes which shows rapid decrease of capacity as the current density increases. Consequently, at high rate charge/discharge, the capacitors according to the present invention have higher specific charge storage capacity than the conventional case. Additionally, Carbon-3 (Example 5), which has superior pore connectivity because of the linear silica template, has larger specific capacitance and specific charge storage capacity than Carbon-1 (Example 1) and Carbon-2 (Example 3).

Electrochemical Capacitors of Mesoporous Carbon/Metal Oxide Composite Materials

### EXAMPLE 17

The experiments on capacitor performance were performed for mesoporous carbons (Examples 1, 3, 5) and mesoporous carbon/metal oxide composite materials (Examples 6 to 11) in 2M sulfuric acid. For electrode fabrication, the carbon or the composite material, Ketjen black, and polytetrafluoroethylene binder were dispersed in isopropyl alcohol by 10:1:1 ratio. The prepared paste was applied by doctor blade to the current collector (1 cm² of stainless steel grid), pressed, and dried in a vacuum oven at 120° C. for 24 hours. A polymer separator (Celgard) was inserted between two identical electrodes, and was pressed by a clip. After sulfuric acid electrolyte solution was injected to the electrodes, the cyclic voltammetry was performed with platinum counter electrode and SCE reference electrode at the scan rate of 1 mV/s.

The specific capacitance can be calculated by dividing current in the cyclic voltammogram by the scan rate and the mass of electrode active material. The composite materials according to the present invention had larger specific capacitance than Carbon-1 (Example 1), as shown in FIG. 15 and FIG. 16, where the specific capacitance plots of the composite materials (Examples 6, 9, 10, and 11) and the carbon (Example 1). Examples 6 to 11 show the increase of specific capacitance with metal oxides loading in common. In TABLE 2, the specific capacitances are listed. FIG. 6 shows the relation between the specific and the residual masses after burning, which is related to the weight ratio of ruthenium oxides, for mesoporous carbon/ruthenium oxide composite material.

TABLE 2

| | | | |
|---|---|---|---|
| | | Residue after | |
| | | burning (%) | |
| | | (% by weight | |
| Exam- | | loaded metal | Specific |
| ple | Electrolyte Solution | oxide) | capacitance (F/g) |

| | | | |
|---|---|---|---|
| 1 | 2M sulfuric acid | 2.6 | 100 |
| 3 | 2M sulfuric acid | 2.0 | 122 |
| 5 | 2M sulfuric acid | 3.1 | 147 |
| 6 | 2M sulfuric acid | 23.5 | 174 |
| 7 | 2M sulfuric acid | 14.0 | 177 |
| 8 | 2M sulfuric acid | 35.6 | 184 |
| 9 | 2M sulfuric acid | 54.3 | 243 |
| 10 | 2M sulfuric acid | 35.7 | 254 |
| 11 | 2M sulfuric acid | 70.1 | 122 |
| 1 | 2M potassium hy- | 2.6 | 26 |
| | droxide | | |
| 12 | 2M potassium hy- | 23.2 | 41 |
| | droxide | | |
| 1 | 2M potassium | 2.6 | 31 |
| | chloride | | |
| 13 | 2M potassium | 23.3 | 62 |
| | chloride | | |

### EXAMPLE 18

The capacitor experiment was performed for the carbon from Example 1 and the composite material from Example 12 in 2M potassium hydroxide solution. The electrode was fabricated in the same way as the Example 12, and the cyclic voltammetry was carried out at 10 mV/s in the voltage range from −0.4 to 0.2V. FIG. 18 shows the capacitance of a the carbon from Example 1 and the composite material from Example 12 in 2M potassium hydroxide solution. The composite material had higher capacitance than the carbon.

### EXAMPLE 19

The capacitor experiment was performed for the carbon Example 1 and the composite material from Example 13 in 2M potassium chloride solution. The electrode was fabricated in the same way as the Example 17, and the titanium grid was used as a current collector. The cyclic voltammetry was carried out at 10 mV/s in the voltage range from −0.2 to 0.8V. The composite material from Example 13 had higher specific capacitance than the carbon from Example 1 in the potassium chloride solution electrolyte (FIG. 19).

The high capacitance of 254 F/g was achieved for the carbon/metal oxide composite material that was prepared by loading metal oxides on the mesoporous carbon having the pore size of 2 to 20 nm, which has the double-layer capacitance of carbon substrate and the pseudo-capacitance of metal oxide at the same time.

### BRIEF DESCRIPTION OF DRAWINGS

FIG. 1 is the schematic procedure for the synthesis of mesoporous carbon in Example 1.

FIG. 2 is the transmission electron microscopy photograph of the mesoporous carbon synthesized in Example 2.

FIG. 3 is the schematic procedure for the synthesis of mesoporous carbon in Example 3.

FIG. 4 is the pore size distributions of the mesoporous carbons synthesized in Example 3 (LUDOX SM-30 silica) and Example 4 (LUDOX HS40 silica), which were measured by the nitrogen adsorption method.

FIG. 5 is the transmission electron microscopy photograph of the mesoporous carbon synthesized in Example 4 (LUDOX HS-40 silica).

FIG. 6 is the schematic procedure for the synthesis of mesoporous carbon in Example 5.

FIG. 7 is the pore size distribution of the mesoporous carbons synthesized in Example 7 (SNOWTEX-UP silica sol), which was measured by the nitrogen adsorption method.

FIG. 8 is the transmission electron microscopy photograph of the mesoporous carbon synthesized in Example 5.

FIG. 9 is the results of thermogravimetric analysis for the composite materials synthesized in Examples 1, 7, 9, 10, 12, and 13.

FIG. 10 is the pore size distributions of the mesoporous carbon synthesized in Example 1 and the composite material synthesized in Example 9, which were measured by the nitrogen adsorption method.

FIG. 11 is the transmission electron microscopy photograph of the mesoporous carbon/NiOₓ composite material in Example 12.

FIGS. 12 to 14 are the comparative graphs of specific charge storage capacity variation of electric double-layer capacitors, which were made by using the conventional carbon material and the mesoporous carbon of the present invention, according to electrolytes and current densities.

FIG. 15 is the cyclic voltammogram of electrodes made by using the mesoporous carbon from Example 1 and the composite materials form Examples 6 and 9 in 2M sulfuric acid electrolyte.

FIG. 16 is the cyclic voltammogram of electrodes made by using the mesoporous carbon from Example 1 and the composite materials from Examples 10 and 11 in 2M sulfuric acid electrolyte.

FIG. 17 is the plot for the relation between the weight percent of residuals after burning and the specific capacitance in 2M sulfuric acid electrolyte for the mesoporous carbons from Examples 1, 3, and 5 and the composite materials from Examples 6 to 11.

FIG. 18 is the cyclic voltammogram of electrodes made by using the mesoporous carbon from Example 1 and the composite material from Example 12 in 2M potassium hydroxide solution electrolyte.

FIG. 19 is the cyclic voltammogram of electrodes made by using the mesoporous carbon from Example 1 and the composite materials from Example 13 in 2M potassium chloride solution electrolyte.

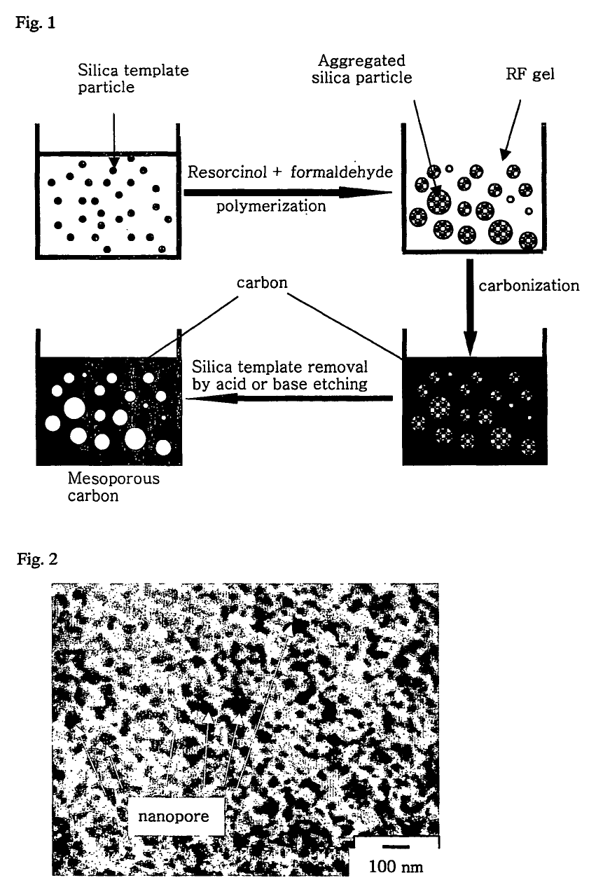

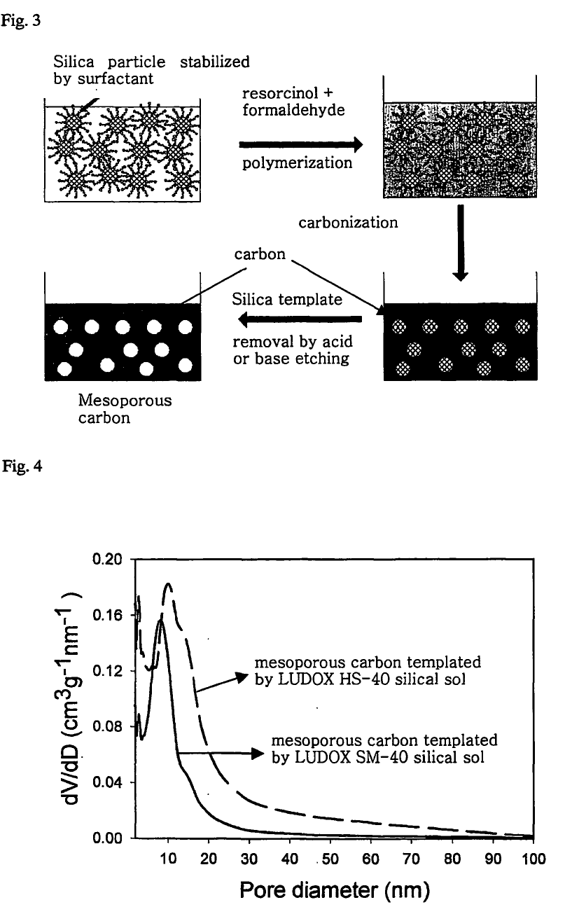

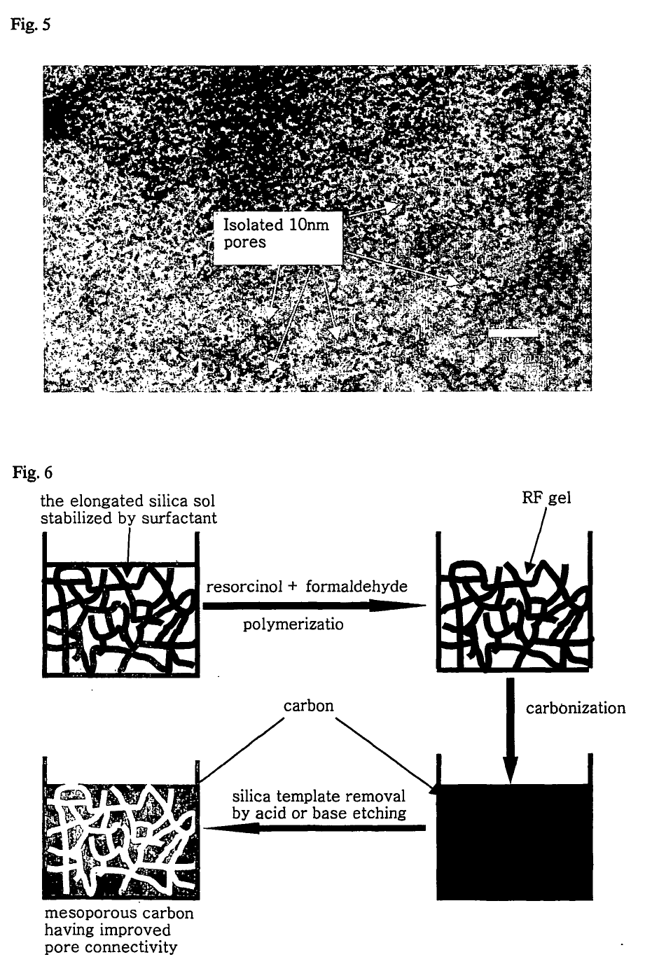

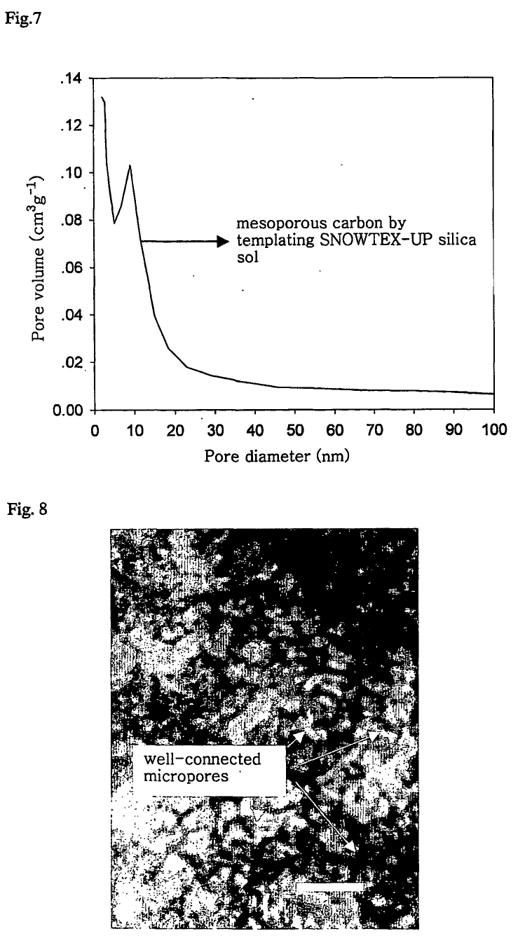

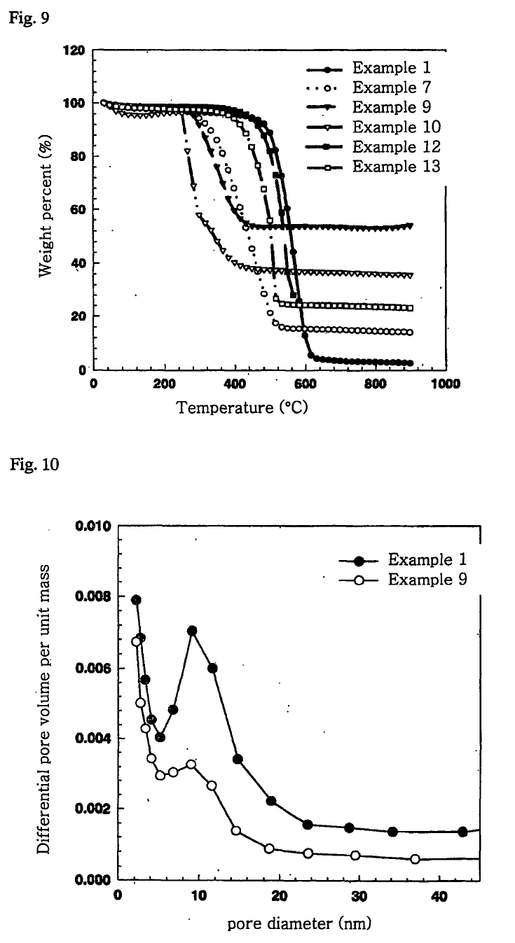

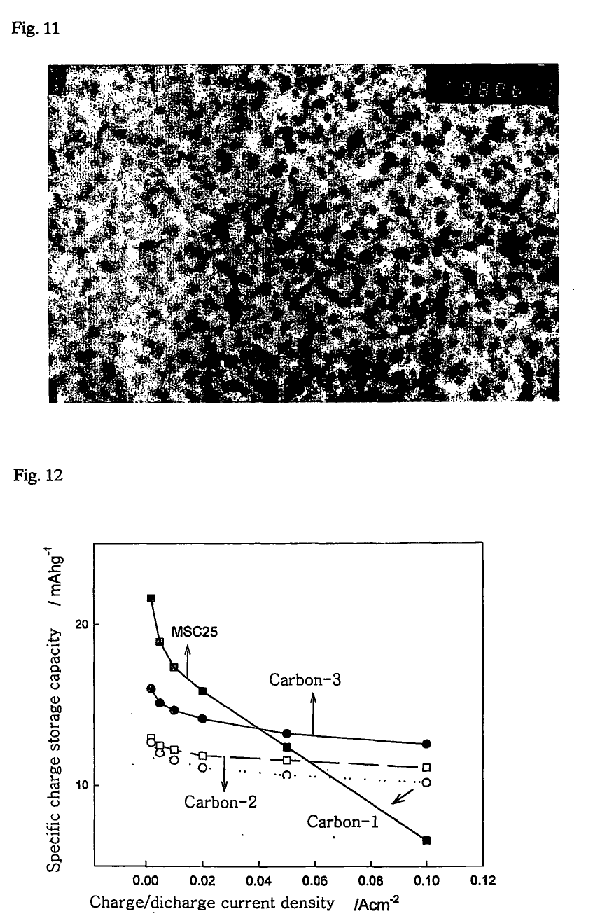

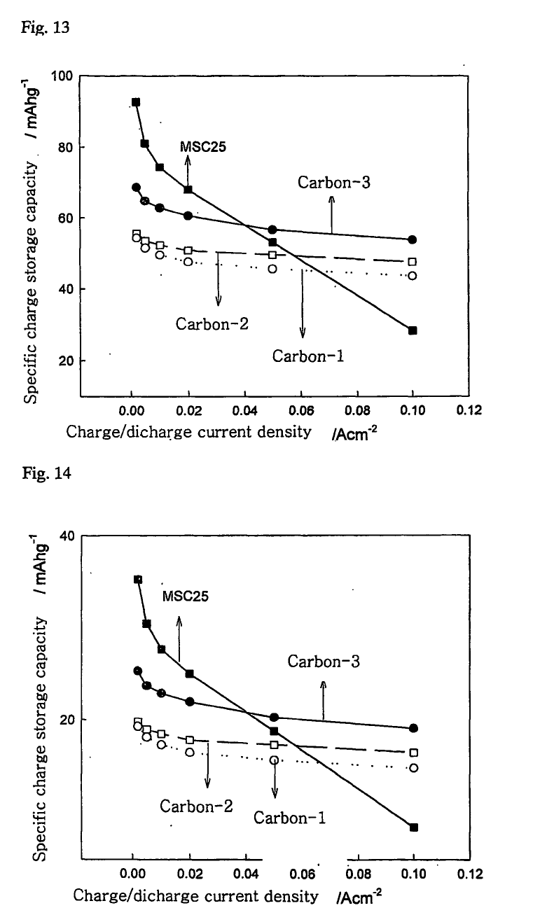

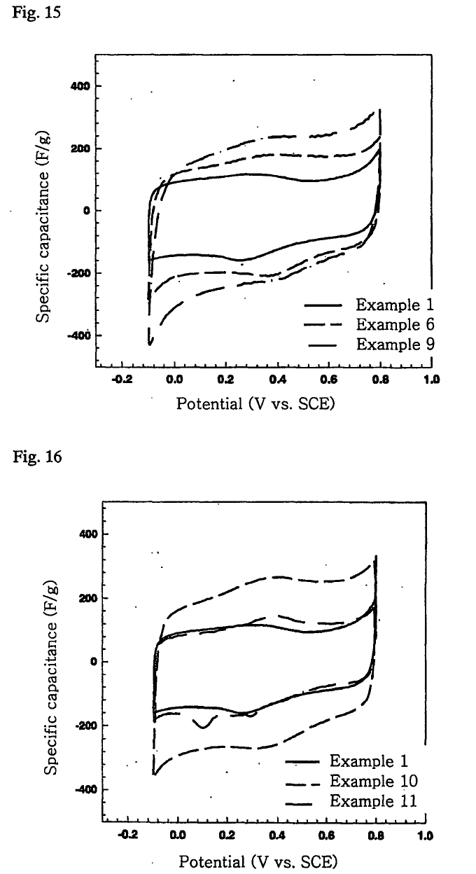

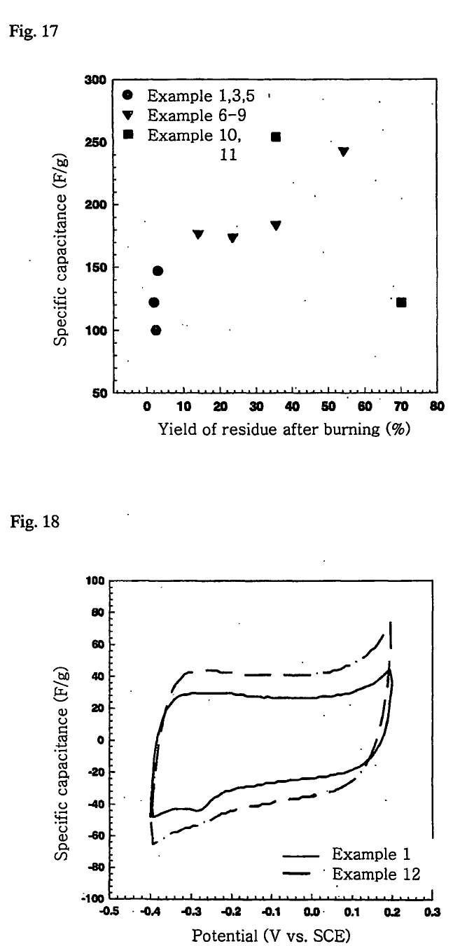

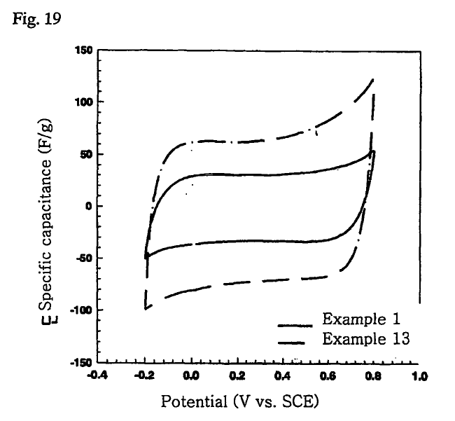

### INDUSTRIAL APPLICABILITY

The mesoporous carbon according to the present invention is synthesized by using inorganic template particles, which permit nanopores structure to be designed in size and shape. In particular, the mesoporous carbons with good pore connectivity can be produced using the inorganic template particles with linear or extended shapes. Although these mesoporous carbons exhibit small specific capacitance in an electric double layer capacitor application because of their small specific surface area, they demonstrate higher charge storage capacity than conventional carbon electrode materials at high charge/discharge current densities, due to small equivalent series resistance of these mesoporous carbons. In addition, as a result of the combination of the electric double-layer capacitance of carbon substrate and the pseudo-capacitance of metal oxide, the high specific capacitance up to 254 F/g can be achieved by using the carbon/metal oxide composite materials that were prepared by loading metal oxides onto these mesoporous carbons as electrode materials for electrochemical capacitors.

What is claimed is:

1. Mesoporous carbon having the pore sizes of ca. 2 to 20 nm, which is synthesized by the method including the following steps of:
(A) preparing “inorganic template/carbon precursor composite” in which the inorganic template particles are well dispersed in the carbon precursor solution,
(B) preparing “inorganic template/carbon precursor” through the carbonization of the carbon precursors surrounding the inorganic templates, by heating the inorganic template/carbon precursor composite at 600 to 1500° C. for 0.5 to 50 hours, and
(C) etching the inorganic template/carbon composite with base or acid to remove the inorganic template, followed by drying.

2. The mesoporous carbons according to claim 1, wherein the inorganic template particles are silica, alumina, titania (TiO₂), or ceria (CeO₂); and the carbon precursors are resorcinol-formaldehyde-gel (RF-gel), phenol-formaldehyde-gel, phenol resin, melamine-formaldehyde-gel, poly(furfuryl alcohol), poly(acrylonitrile), sucrose, or petroleum pitch.

3. The mesoporous carbons according to claim 2, wherein the inorganic template particles are linear or extended silica.

4. The mesoporous carbons according to claim 1 or 2, wherein the inorganic particle/carbon precursor composites in said step (A) are synthesized by preparing the aqueous sol containing the inorganic particles in 20 to 60% by weight percent, adding the mixture of resorcinol and formaldehyde with mole ratio of 1:2 to 1:3 to the inorganic aqueous sol with molar ratio of 1:1 to 1:20, and polymerizing the resultant at 20 to 95° C.

5. The mesoporous carbons according to claim 1 or 2, wherein the inorganic particle/carbon precursor composites in said step (A) are synthesized by preparing the aqueous sol containing the inorganic particles in 20 to 60% by weight, and adding the carbon precursor solution made by dissolving the carbon precursors including phenol resin, melamine-formaldehyde-gel, poly(furfuryl alcohol), poly(acrylonitrile), sucrose, or petroleum pitch in organic solvents at 10 to 100% by weight to the inorganic aqueous sol by 1:1 to 1:20 in mole ratio.

6. The mesoporous carbons according to one of claims 1 to 3, wherein the inorganic particles are stabilized by surfactants.

7. The mesoporous carbons according to claim 4, wherein the additional step is further included, after said step (A), that the mixture is aged at room temperature to 120° C. for 1 to 10 days and is washed by distilled water to remove unreacted species.

8. Carbon/metal oxide composite materials with metal oxides deposited into the pores of the mesoporous carbons of claim 1.

9. The carbon/metal oxide composite materials according to claim 8, wherein the composite materials are synthesized by the method including the following steps:
(a) synthesizing the composites of the mesoporous carbons and metal oxide precursors, and
(b) converting the carbon/metal oxide precursor composites to carbon/metal oxides by heat-treatment to synthesize the carbon/metal oxide composite materials.

10. The carbon/metal oxide composite materials according to claim 9, wherein the mesoporous carbon/metal oxide precursor composites in said step (a) are synthesized by gas phase method including the following steps:
(a-1) mixing the mesoporous carbons and the metal oxide precursors in a reactor,
(b-1) converting the metal oxide precursors to gas phase by heating the mixture under reduced pressure, and.
(c-1) cooling the reactor to make the mesoporous carbon/metal oxide precursor composite materials.

11. The carbon/metal oxide composite materials according to claim 9, wherein the mesoporous carbon/metal oxide precursor composites in said step (a) are synthesized by liquid phase method including the following steps:
(a-2) evacuating a reactor containing the mesoporous carbons,
(b-2) injecting a metal salt solution into the reactor to wet the mesoporous carbons, and
(c-2) removing a solvent is from the reactor to make the mesoporous carbon/metal oxide precursor composite materials.

12. The carbon/metal oxide composite materials according to claim 10, wherein in said step (a-1), the metal oxide precursor is one or a mixture of two or more selected from the group consisting of acetylacetonates, chlorides, fluorides, sulfuric salt, and nitric salt of transition metal elements (Ti, Zr, V, Nb, Ta, Cr, Mo, W, Mn, Fe, Co, Ir, Ni, Pd, Ru);
in said step (b-1), the reactor is heated under the reduced pressure up to the temperature that the metal oxide precursor can be sublimed to make the metal oxide precursor vapor that can be well-dispersed into the pores of the mesoporous carbons;
in said step (c-1), the following cooling methods are applied in the synthesis: cooling rates of 0.1 to 10° C./min, application of different cooling rate depending at different temperatures, and keeping a constant temperature in the middle of cooling process.

13. The carbon/metal oxide composite materials according to claim 11, wherein in said step (a-2), the reactor is heated under the reduced pressure to remove water and organic materials in the carbon pores followed by cooling down to room temperature;
in said step (b-2), the metal salt applied in the metal salt solution preparation is one or a mixture of two or more selected from the group consisting of nitric salts, sulfuric salts, carbonates, acetylacetonates, bromides, chlorides, fluorides, and hydroxides of transition metal elements such as Ti, Zr, V, Nb, Ta, Cr, Mo, W, Mn, Fe, Co, Ir, Ni, Pd, and Ru;
in said step (c-2), the removal of solvent is carried out at the temperature between 20° C. and the boiling point of the solvent under atmospheric pressure.

14. The carbon/metal oxide composite materials according to claim 9, wherein the heat-treatment in said step (b) is carried out by heating the mesoporous carbon/metal oxide precursor composite under an inert gas atmosphere, at the flow rate of 1 to 20 cc/min, with the heating rate of 1 to 10° C./min, the temperature up to 100 to 500° C., and holding at the specified temperature for 5 min to 30 hours.

15. Electric double-layer capacitors comprising electrodes that are made by applying the mesoporous carbons of claim 1 to current collectors; separators between the electrodes; and an electrolyte solution infiltrated in the electrodes and the separators.

16. Electrochemical capacitor comprising electrodes that are made by applying the carbon/metal oxide composite materials of claim 8 to current collectors; separators inserted between the electrodes; and an electrolyte solution infiltrated in the electrodes and the separators.

17. The electrochemical capacitor according to claim 16, wherein polymer, glass fiber matt, craft paper, Celgard series separator, and polypropylene separator are applied as the separator to prevent internal short-circuit of two electrodes and to retain electrolyte solution;
to 20% by weight of carbon black is added as a conducting material to decrease further the electrode resistance.

18. The carbon/metal oxide composite materials according to claim 16 or 17, wherein 5 to 100% aqueous sulfuric acid solution and 0.5 to 20M aqueous potassium hydroxide solution are applied as the electrolyte solution.

19. The carbon/metal oxide composite materials according to claim 16 or 17, wherein the electrodes are laminated-type electrodes and the laminated-type electrodes are fabricated by the following steps: the mixture of carbon/metal oxide powder and binder with weight ratio of 10:0.5 to 2 is added to a dispersing agent, and the resultant solution is stirred to prepare a paste, which is applied to metal current collector, and the electrode is pressed and dried.

20. The carbon/metal oxide composite materials according to claim 19, wherein polytetrafluoroethylene (PTFE), polyvinylidene fluoride (PVdF), cellulose and the like are used as the binder; isopropyl alcohol, N-methylpyrrolridone (NMP), acetone and the like are used as the dispersing agent; mesh or foil, made of stainless steel, titanium, and aluminum, are used as the current collector.
